(19) United States
(12) Patent Application Publication
(10) Pub. No.: US 2017/0220875 A1
(43) Pub. Date: Aug. 3, 2017

(54) SYSTEM AND METHOD FOR DETERMINING A VISIBILITY STATE

(71) Applicant: Faraday&Future Inc., Gardena, CA (US)

(72) Inventor: Oliver Max JEROMIN, Torrance, CA (US)

(21) Appl. No.: 15/418,332

(22) Filed: Jan. 27, 2017

Related U.S. Application Data
(60) Provisional application No. 62/288,873, filed on Jan. 29, 2016.

(51) Int. Cl. G06K 9/00; H04N 5/235; B60R 11/04; G06T 7/13; B60Q 1/20; H04N 13/02; G06T 7/285

(52) U.S. Cl. CPC G06K 9/00791; H04N 13/0271; H04N 5/2354; G06T 7/285; G06T 7/13; H04N 13/0253; H04N 13/0239; H04N 13/0207; B60Q 1/20; B60R 11/04; G06T 2207/10012; G06T 2207/10028; G06T 2207/20228; G06T 2207/30252; B60Q 2300/312

(57) ABSTRACT

The present invention is generally directed to methods and systems of estimating visibility around a vehicle and automatically configuring one or more systems in response to the visibility level. The visibility level can be estimated by comparing two images of the vehicle's surroundings, each taken from a different perspective. Distance of objects in the images can be estimated based on the disparity between the two images, and the visibility level (e.g., a distance) can be estimated based on the farthest object that is visible in the images.

### CROSS REFERENCE TO RELATED APPLICATION

This application claims the benefit of U.S. Provisional Patent Application No. 62/288,873, filed on Jan. 29, 2016, the entire disclosure of which is incorporated herein by reference in its entirety for all intended purposes.

### FIELD OF THE DISCLOSURE

The embodiments of the present invention relates generally to a system and method for determining visibility around a vehicle, such as an automobile.

### BACKGROUND OF THE DISCLOSURE

Modern vehicles, especially automobiles, increasingly provide automated driving and driving assistance systems such as blind spot monitors, automatic parking, and automatic navigation. However, automated driving systems can rely on cameras and other optical imagers that can be less reliable in reduced visibility situations, such as when heavy fog is present.

### SUMMARY OF THE DISCLOSURE

Examples of the disclosure are directed to methods and systems of estimating visibility around a vehicle and automatically configuring one or more systems in response to the visibility level. The visibility level can be estimated by comparing two images of the vehicle's surroundings, each taken from a different perspective. Distance of objects in the images can be estimated based on the disparity between the two images, and the visibility level (e.g., a distance) can be estimated based on the farthest object that is visible in the images.

### BRIEF DESCRIPTION OF THE DRAWINGS

FIGS. 1A-1D illustrate exemplary depth maps according to examples of the disclosure.

FIG. 2 illustrates an exemplary method of estimating visibility around a vehicle according to examples of the disclosure.

FIG. 3 illustrates a system block diagram according to examples of the disclosure.

### DETAILED DESCRIPTION

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples.

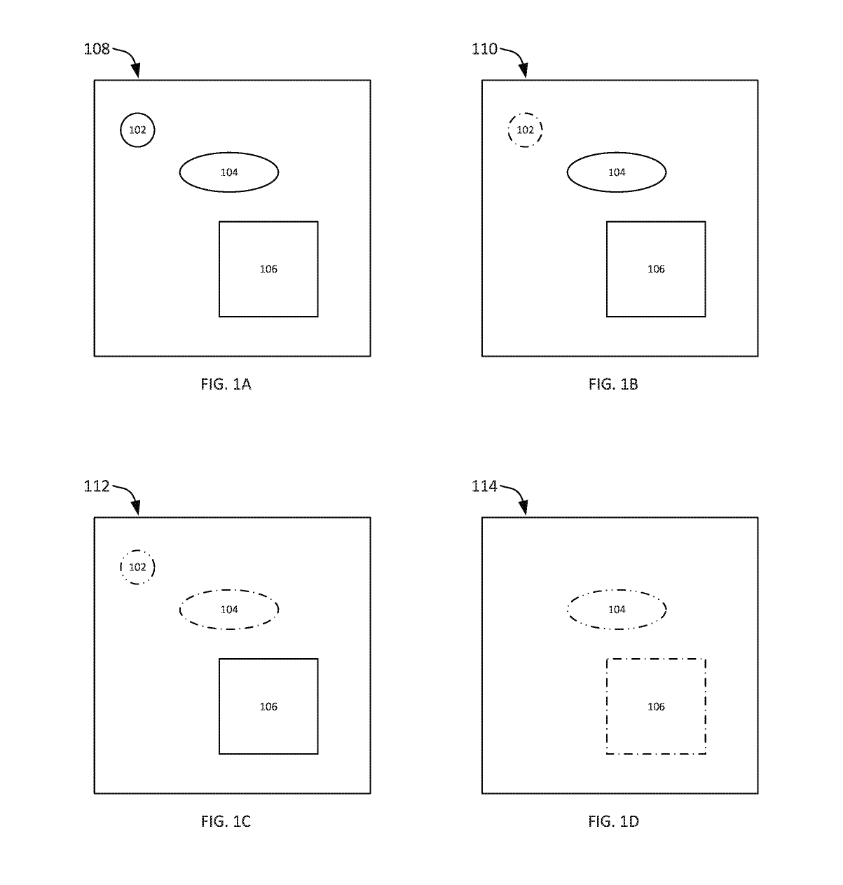

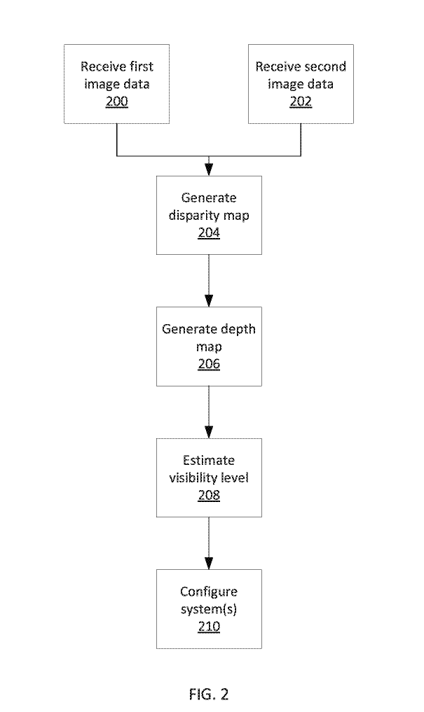

FIGS. 1A-1D illustrate exemplary depth maps according to examples of the disclosure. In some examples, a depth map of a vehicle's surroundings can be created based on two images of the surroundings, each taken from a different perspective. For example, the two images can be captured from two different image sensors (e.g., that make up a stereo camera) or from a single camera that moves after capturing the first image (e.g., a side-facing camera mounted to a vehicle that takes the two pictures in succession while the vehicle is moving). Methods of generating a depth map are described below with reference to FIG. 2.

Each depth map 108, 110, 112, and 114 illustrates the same scene of objects 102, 104, and 106 with different levels of visibility in each depth map. Depth map 108 has the most visibility, depth map 110 has relatively less visibility than depth map 108, depth map 112 has relatively less visibility than depth map 110, and depth map 114 has the least visibility. Further, each object 102, 104, and 106 is at a different distance, with object 102 being a distance of 150 meters from the camera, object 104 being a distance of 100 meters from the camera, and object 106 being a distance of 50 meters from the camera.

In some examples, the visibility level can be estimated based on the furthest visible object. For example, for depth maps 108, 110, and 112, the furthest visible object is object 102 at 150 meters, and in each case the visibility level can be estimated as being 150 meters of visibility. In contrast, for depth map 114, the furthest visible object is object 104 at 100 meters, and the visibility level can be estimated as being 100 meters of visibility.

In some examples, the visibility level can be estimated based on a threshold density of the depth map. Such a heuristic can be useful because some objects may still be barely visible in fog, but not visible enough to be safely navigated by a human driver or by an automated/assisted driving system. In such a case, the visibility level can be estimated based on the furthest distance in the depth map that has a pixel density over a predetermined threshold density. For example, in depth map 112, object 102 is still visible at 150 meters but the pixel density may be below the predetermined threshold density and thus its distance may not be used as the estimated visibility level. Instead, object 104 at 100 meters, having a pixel density exceeding the predetermined threshold density, may be used as the estimated visibility level. Similarly, in depth map 114, object 104 is still visible at 100 meters but the pixel density may be below the predetermined threshold density and thus its distance may not be used as the estimated visibility level. Instead, object 106 at 50 meters, having a pixel density exceeding the predetermined threshold density, may be used as the estimated visibility level. In some examples, a Kalman filter may be used on depth map data gathered over time to determine changes in estimated visibility levels.

In some examples, the depth map density threshold comparison may take into account a range of distances when determining an estimated visibility level. For example, all pixels between 45-55 meters may be taken into account when calculating pixel density and comparing to the predetermined density threshold. If those pixels exceed the threshold, but the pixels from 50-60 meters do not exceed the threshold, then the estimated visibility level may be 45-55 meters, 45 meters (the low end of the range), 50 meters (the mean of the range), or 55 meters (the high end of the range), among other possibilities. In some examples, the estimated visibility level may not be expressed as a distance, but as qualitative levels (e.g., low, medium, or high) or numbers representing qualitative levels (e.g., a floating point value on the interval [0,1]).

FIG. 2 illustrates an exemplary method of estimating visibility around a vehicle according to examples of the disclosure. The vehicle (e.g., electronic components of the vehicle, such as a processor, a controller, or an electronic control unit) can receive first image data (200) and second image data (202) from one or more image sensors mounted on the vehicle. For example, the one or more image sensors mounted on the vehicle may include a stereo camera with a first image sensor and a second image sensor, wherein the first image data is captured by the first image sensor and the second image data is captured by the second image sensor. In some examples, the one or more image sensors mounted on the vehicle may include a first image sensor (e.g., a side facing camera), and both the first and second image data may be captured by the same first image sensor (e.g., at different times while the vehicle is in motion).

The vehicle can generate (204) a disparity map between the first image data and the second image data, and the vehicle can further generate (206) a depth map based on the disparity map. For example, a disparity map may be generated that captures the disparity or displacement of each pixel between the two images. Pixels can be co-located in the two images that belong to the same object. Co-locating pixels in images from different views can take into account color, shape, edges, etc. of features in the image data. For example, in a simple example, a dark red object that is the size of a single pixel in an image can be simply located in the two sets of image data, especially if the red object is against a white background. If the pixel corresponding to the red object is in a different position in the two sets of image data, a disparity can be determined for the red object between the two sets. This disparity may be inversely proportional to the distance of the red object from the vehicle (i.e., a smaller disparity indicates the object is farther from the vehicle, and a larger disparity indicates the object is closer to the vehicle).

The disparity value can be used to triangulate the object to create a distance map. A distance estimate for each pixel that is co-located between the two sets of image data can be calculated based on the disparity value for that pixel and the baseline distance between the two images. In the stereo camera case, the baseline distance may be the distance between the two image sensors in the stereo camera. In the case of a single side-facing camera and a moving vehicle, the baseline distance may be calculated based on the speed of the vehicle (e.g., received from a speed sensor) and the time difference between the two images (e.g., obtained from metadata generated when images are captured from the image sensor). Examples of this “depth from motion” process are described in U.S. Pat. No. 8,837,811, entitled “Multi-stage linear structure from motion,” the contents of which is hereby incorporated by reference for all purposes. In some examples, other information, such as the focal length of each image sensor, can also be used in determining distance estimates for each pixel. In this way, a depth map can be generated including a set of distance estimates for each pixel that can be co-located between the two sets of image data.

The vehicle can then estimate (208) a visibility level based on the disparity map (and/or the depth map generated from the disparity map) between the first image data and the second image data. In some examples, the visibility level can be estimated based on the furthest visible object in the depth map, as described in greater detail with respect to FIG. 1. For example, if the furthest visible object in the depth map is at 150 meters, then the visibility level can be estimated as being 150 meters.

In some examples, the visibility level can be estimated based on a threshold density, as described in greater detail with respect to FIG. 1. For example, the vehicle can determine a first density of pixels at a first distance in the depth map, and a second density of pixels at a second distance in the depth map. The estimated visibility level may be based on the first distance in the depth map in accordance the first density exceeding a predetermined density threshold, and the estimated visibility level may be based on the second distance in the depth map in accordance with the second density exceeding the predetermined density threshold and the first density not exceeding the predetermined density threshold.

In some examples, the vehicle may configure and/or reconfigure (210) one or more systems of the vehicle based on the estimated visibility level. For example, the vehicle may increase the brightness of one or more lights of the vehicle in accordance with the estimated visibility level being below a predetermined threshold (e.g., if there is low visibility due to fog, the lights may need to be brighter to increase visibility). In some examples, the vehicle may activate one or more fog lights of the vehicle in accordance with the estimated visibility level being below a predetermined threshold (e.g., if there is low visibility due to fog, fog lights may be needed). In some examples, the predetermined threshold may be based on regulations for fog lights in a locality (e.g., if the law requires fog lights in 50 meter visibility or less).

In some examples, the vehicle may reconfigure or disable automated/assisted driving systems in response to a relatively low estimated visibility level. For example, certain driving assistance systems may be disabled if they rely on cameras or other optical systems that may be impacted by low visibility. Similarly, alternate systems may be enabled that rely on other sensors, such as ultrasonic sensors that would not be impacted by low visibility. In some embodiments, confidence levels of certain sensors or systems may be adjusted proportionally to changes in visibility. For example, if an assisted/automated driving system weighs information from both optical and non-optical sensors, the information from optical sensors may be weighted more heavily when visibility is relatively high and may be weighted less heavily when visibility is relatively low.

In some examples, any/all of the visibility level estimation process (e.g., capturing images, generating disparity or depth map, etc.) may be triggered at regular intervals (e.g., every 3 seconds, every minute, etc.). In some examples, heuristics can be used to trigger the more computationally intensive parts of the process (e.g., generating disparity or depth maps) only when an indication of a change in visibility is detected. For example, sharp edges (e.g., horizons, edges of objects, etc.) can become less sharp or more blurry when visibility is decreased. By detecting edges in the captured images and determining one or more properties of the edge (e.g., sharpness, gradient, etc.) and how the properties change over time, a change in visibility can be detected and map generation can be triggered. In one example, sharpness of a horizon can be tracked across multiple images captured over time. As long as the sharpness exceeds a predetermined threshold (e.g., indicating relatively high visibility), no disparity/depth maps may be generated. Then, when the sharpness falls below the predetermined threshold (e.g., indicating a decrease in visibility), the disparity and depth maps may be generated and the visibility level may be estimated accordingly.

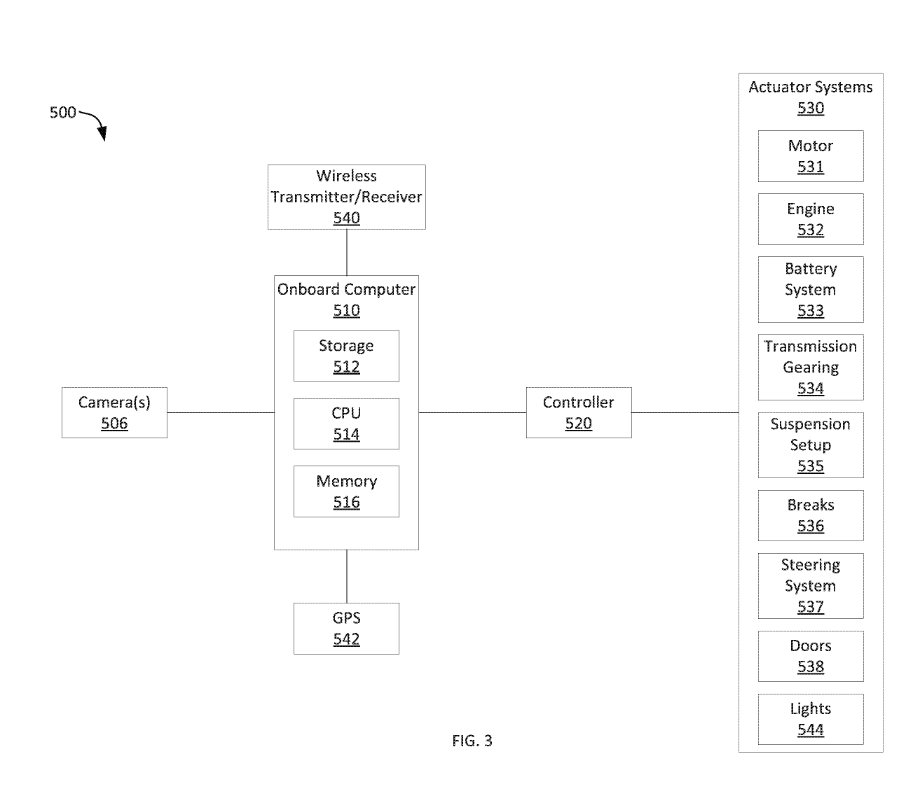

FIG. 3 illustrates a system block diagram of a vehicle according to examples of the disclosure. Vehicle control system 500 can perform any of the methods described with reference to FIGS. 1A-2. System 500 can be incorporated into a vehicle, such as a consumer automobile. Other example vehicles that may incorporate the system 500 include, without limitation, airplanes, boats, or industrial automobiles. Vehicle control system 500 can include one or more cameras 506 capable of capturing image data (e.g., video data), as previously described. Vehicle control system 500 can include an on-board computer 510 coupled to the cameras 506, and capable of receiving the image data from the camera, as described in this disclosure. On-board computer 510 can include storage 512, memory 516, and a processor 514. Processor 514 can perform any of the methods described with reference to FIGS. 1A-2. Additionally, storage 512 and/or memory 516 can store data and instructions for performing any of the methods described with reference to FIGS. 1A-2. Storage 512 and/or memory 516 can be any non-transitory computer readable storage medium, such as a solid-state drive or a hard disk drive, among other possibilities. The vehicle control system 500 can also include a controller 520 capable of controlling one or more aspects of vehicle operation.

In some examples, the vehicle control system 500 can be connected to (e.g., via controller 520) one or more actuator systems 530 in the vehicle. The one or more actuator systems 530 can include, but are not limited to, a motor 531 or engine 532, battery system 533, transmission gearing 534, suspension setup 535, brakes 536, steering system 537 door system 538, and lights system 544. Based on the determined locations of one or more objects relative to the vehicle, the vehicle control system 500 can control one or more of these actuator systems 530 (e.g., lights 544) in response to changes in visibility. The camera system 506 can continue to capture images and send them to the vehicle control system 500 for analysis, as detailed in the examples above. The vehicle control system 500 can, in turn, continuously or periodically send commands to the one or more actuator systems 530 to control configuration of the vehicle.

Thus, the examples of the disclosure provide various ways to safely and efficiently configure systems of the vehicle in response to changes in visibility, for example, due to fog.

Therefore, according to the above, some examples of the disclosure are directed to a method of estimating visibility around a vehicle, the method comprising: receiving first image data and second image data from one or more image sensors mounted on the vehicle; generating a disparity map between the first image data and the second image data; and estimating a visibility level based on the disparity map between the first image data and the second image data. Additionally or alternatively to one or more of the examples disclosed above, in some examples, the method further comprises: increasing the brightness of one or more lights of the vehicle in accordance with the estimated visibility level being below a predetermined threshold. Additionally or alternatively to one or more of the examples disclosed above, in some examples, the method further comprises: activating one or more fog lights of the vehicle in accordance with the estimated visibility level being below a predetermined threshold. Additionally or alternatively to one or more of the examples disclosed above, in some examples, the method further comprises: disabling a driving assistance system in accordance with the estimated visibility level being below a predetermined threshold. Additionally or alternatively to one or more of the examples disclosed above, in some examples, the method further comprises: reducing a confidence level of a driving assistance system in accordance with the estimated visibility level being below a predetermined threshold. Additionally or alternatively to one or more of the examples disclosed above, in some examples, the one or more image sensors mounted on the vehicle include a stereo camera with a first image sensor and a second image sensor, the first image data is captured by the first image sensor, and the second image data is captured by the second image sensor. Additionally or alternatively to one or more of the examples disclosed above, in some examples, the first image sensor is a baseline distance from the second image sensor, the method further comprising: generating a depth map based on the disparity map and the baseline distance, wherein the estimated visibility level is based on the generated depth map. Additionally or alternatively to one or more of the examples disclosed above, in some examples, the one or more image sensors mounted on the vehicle include a first image sensor, and both the first and second image data are captured by the first image sensor. Additionally or alternatively to one or more of the examples disclosed above, in some examples, the method further comprises: receiving a speed of the vehicle; computing a baseline distance based on the speed of the vehicle and a time difference between the first image data and the second image data; and generating a depth map based on the disparity map and the baseline distance, wherein the estimated visibility level is based on the generated depth map. Additionally or alternatively to one or more of the examples disclosed above, in some examples, the method further comprises: detecting a first edge in the first image data; determining a property of the first edge in the first image data; in accordance with the property of the first edge not exceeding a predetermined threshold, generating the disparity map; and in accordance with the property of the first edge exceeding the predetermined threshold, forgoing generation of the disparity map. Additionally or alternatively to one or more of the examples disclosed above, in some examples, the method further comprises: generating a depth map based on the disparity map; and determining a first density of pixels at a first distance in the depth map, wherein the estimated visibility level is based on the first density of pixels at the first distance in the depth map. Additionally or alternatively to one or more of the examples disclosed above, in some examples, the method further comprises: determining a second density of pixels at a second distance in the depth map; wherein the estimated visibility level is based on the first distance in the depth map in accordance the first density exceeding a predetermined density threshold; wherein the estimated visibility level is based on the second distance in the depth map in accordance with the second density exceeding the predetermined density threshold and the first density not exceeding the predetermined density threshold.

Some examples of the disclosure are directed to a non-transitory computer readable storage medium storing instructions which, when executed by a vehicle including one or more processors, cause the vehicle to perform a method of estimating visibility around the vehicle, the method comprising: receiving first image data and second image data from one or more image sensors mounted on the vehicle; generating a disparity map between the first image data and the second image data; and estimating a visibility level based on the disparity map between the first image data and the second image data. Additionally or alternatively to one or more of the examples disclosed above, in some examples, the method further comprises: increasing the brightness of one or more lights of the vehicle in accordance with the estimated visibility level being below a predetermined threshold. Additionally or alternatively to one or more of the examples disclosed above, in some examples, the method further comprises: activating one or more fog lights of the vehicle in accordance with the estimated visibility level being below a predetermined threshold. Additionally or alternatively to one or more of the examples disclosed above, in some examples, the method further comprises: disabling a driving assistance system in accordance with the estimated visibility level being below a predetermined threshold. Additionally or alternatively to one or more of the examples disclosed above, in some examples, the method further comprises: reducing a confidence level of a driving assistance system in accordance with the estimated visibility level being below a predetermined threshold. Additionally or alternatively to one or more of the examples disclosed above, in some examples, the one or more image sensors mounted on the vehicle include a stereo camera with a first image sensor and a second image sensor, the first image data is captured by the first image sensor, and the second image data is captured by the second image sensor. Additionally or alternatively to one or more of the examples disclosed above, in some examples, the first image sensor is a baseline distance from the second image sensor, and the method further comprises: generating a depth map based on the disparity map and the baseline distance, wherein the estimated visibility level is based on the generated depth map. Additionally or alternatively to one or more of the examples disclosed above, in some examples, the one or more image sensors mounted on the vehicle include a first image sensor, and both the first and second image data are captured by the first image sensor. Additionally or alternatively to one or more of the examples disclosed above, in some examples, the method further comprises: receiving a speed of the vehicle; computing a baseline distance based on the speed of the vehicle and a time difference between the first image data and the second image data; and generating a depth map based on the disparity map and the baseline distance, wherein the estimated visibility level is based on the generated depth map. Additionally or alternatively to one or more of the examples disclosed above, in some examples, the method further comprises: detecting a first edge in the first image data; determining a property of the first edge in the first image data; in accordance with the property of the first edge not exceeding a predetermined threshold, generating the disparity map; and in accordance with the property of the first edge exceeding the predetermined threshold, forgoing generation of the disparity map. Additionally or alternatively to one or more of the examples disclosed above, in some examples, the method further comprises: generating a depth map based on the disparity map; and determining a first density of pixels at a first distance in the depth map, wherein the estimated visibility level is based on the first density of pixels at the first distance in the depth map. Additionally or alternatively to one or more of the examples disclosed above, in some examples, the method further comprises: determining a second density of pixels at a second distance in the depth map; wherein the estimated visibility level is based on the first distance in the depth map in accordance the first density exceeding a predetermined density threshold; wherein the estimated visibility level is based on the second distance in the depth map in accordance with the second density exceeding the predetermined density threshold and the first density not exceeding the predetermined density threshold.

Some examples of the disclosure are directed to a vehicle, comprising: one or more processors; one or more image sensors; a memory storing one or more instructions which, when executed by the one or more processors, cause the vehicle to perform a method of estimating visibility around the vehicle, the method comprising: receiving first image data and second image data from the one or more image sensors mounted on the vehicle; generating a disparity map between the first image data and the second image data; and estimating a visibility level based on the disparity map between the first image data and the second image data. Additionally or alternatively to one or more of the examples disclosed above, in some examples, the method further comprises: increasing the brightness of one or more lights of the vehicle in accordance with the estimated visibility level being below a predetermined threshold. Additionally or alternatively to one or more of the examples disclosed above, in some examples, the method further comprises: activating one or more fog lights of the vehicle in accordance with the estimated visibility level being below a predetermined threshold. Additionally or alternatively to one or more of the examples disclosed above, in some examples, the method further comprises: disabling a driving assistance system in accordance with the estimated visibility level being below a predetermined threshold. Additionally or alternatively to one or more of the examples disclosed above, in some examples, the method further comprises: reducing a confidence level of a driving assistance system in accordance with the estimated visibility level being below a predetermined threshold. Additionally or alternatively to one or more of the examples disclosed above, in some examples, the one or more image sensors mounted on the vehicle include a stereo camera with a first image sensor and a second image sensor, the first image data is captured by the first image sensor, and the second image data is captured by the second image sensor. Additionally or alternatively to one or more of the examples disclosed above, in some examples, the first image sensor is a baseline distance from the second image sensor, the method further comprising: generating a depth map based on the disparity map and the baseline distance, wherein the estimated visibility level is based on the generated depth map. Additionally or alternatively to one or more of the examples disclosed above, in some examples, the one or more image sensors mounted on the vehicle include a first image sensor, and both the first and second image data are captured by the first image sensor. Additionally or alternatively to one or more of the examples disclosed above, in some examples, the method further comprises: receiving a speed of the vehicle; computing a baseline distance based on the speed of the vehicle and a time difference between the first image data and the second image data; and generating a depth map based on the disparity map and the baseline distance, wherein the estimated visibility level is based on the generated depth map. Additionally or alternatively to one or more of the examples disclosed above, in some examples, the method further comprises: detecting a first edge in the first image data; determining a property of the first edge in the first image data; in accordance with the property of the first edge not exceeding a predetermined threshold, generating the disparity map; and in accordance with the property of the first edge exceeding the predetermined threshold, forgoing generation of the disparity map. Additionally or alternatively to one or more of the examples disclosed above, in some examples, the method further comprises: generating a depth map based on the disparity map; and determining a first density of pixels at a first distance in the depth map, wherein the estimated visibility level is based on the first density of pixels at the first distance in the depth map. Additionally or alternatively to one or more of the examples disclosed above, in some examples, the method further comprises: determining a second density of pixels at a second distance in the depth map; wherein the estimated visibility level is based on the first distance in the depth map in accordance the first density exceeding a predetermined density threshold; wherein the estimated visibility level is based on the second distance in the depth map in accordance with the second density exceeding the predetermined density threshold and the first density not exceeding the predetermined density threshold.

Although examples of this disclosure have been fully described with reference to the accompanying drawings, it is to be noted that various changes and modifications will become apparent to those skilled in the art. Such changes and modifications are to be understood as being included within the scope of examples of this disclosure as defined by the appended claims.

1. A non-transitory computer readable storage medium storing instructions which, when executed by a vehicle including one or more processors, cause the vehicle to perform a method of estimating visibility around the vehicle, the method comprising the steps of:
receiving first image data and second image data from one or more image sensors mounted on the vehicle;
generating a disparity map between the first image data and the second image data; and
estimating a visibility level based on the disparity map between the first image data and the second image data.

2. The non-transitory computer readable storage medium of claim 1, the method further comprising the step of increasing the brightness of one or more lights of the vehicle in accordance with the estimated visibility level being below a predetermined threshold.

3. The non-transitory computer readable storage medium of claim 1, the method further comprising the step of activating one or more fog lights of the vehicle in accordance with the estimated visibility level being below a predetermined threshold.

4. The non-transitory computer readable storage medium of claim 1, the method further comprising the step of: disabling a driving assistance system in accordance with the estimated visibility level being below a predetermined threshold.

5. The non-transitory computer readable storage medium of claim 1, the method further comprising the step of reducing a confidence level of a driving assistance system in accordance with the estimated visibility level being below a predetermined threshold.

6. The non-transitory computer readable storage medium of claim 1, wherein the vehicle includes a stereo camera comprising a first image sensor and a second image sensor, the first image data is captured by the first image sensor, and the second image data is captured by the second image sensor.

7. The non-transitory computer readable storage medium of claim 6, the method further comprising the step of generating a depth map based on the disparity map and a baseline distance, wherein said baseline distance is a distance between the first and the second image sensor, and wherein the estimated visibility level is based on the generated depth map.

8. The non-transitory computer readable storage medium of claim 1, wherein the vehicle include a first image sensor, and both the first and second image data are captured by the first image sensor.

9. The non-transitory computer readable storage medium of claim 8, the method further comprising the steps of:
determining a speed of the vehicle;
computing a baseline distance based on the speed of the vehicle and a time difference between the first image data and the second image data; and
generating a depth map based on the disparity map and the baseline distance, wherein the estimated visibility level is based on the generated depth map.

10. The non-transitory computer readable storage medium of claim 1, the method further comprising the steps of:
detecting a first edge in the first image data;
determining a property of the first edge in the first image data;
in accordance with the property of the first edge not exceeding a predetermined threshold, generating the disparity map; and
in accordance with the property of the first edge exceeding the predetermined threshold, forgoing generation of the disparity map.

11. The non-transitory computer readable storage medium of claim 1, the method further comprising the steps of:
generating a depth map based on the disparity map; and
determining a first density of pixels at a first distance in the depth map, wherein the estimated visibility level is based on the first density of pixels at the first distance in the depth map.

12. The non-transitory computer readable storage medium of claim 11, the method further comprising the steps of:
determining a second density of pixels at a second distance in the depth map;
wherein the estimated visibility level is based on the first distance in the depth map in accordance the first density exceeding a predetermined density threshold;
wherein the estimated visibility level is based on the second distance in the depth map in accordance with the second density exceeding the predetermined density threshold and the first density not exceeding the predetermined density threshold.

13. A vehicle, comprising:
one or more processors;
one or more image sensors
a memory storing one or more instructions which, when executed by the one or more processors, cause the vehicle to perform a method of estimating visibility around the vehicle, the method comprising the steps of:
receiving first image data and second image data from the one or more image sensors mounted on the vehicle;
generating a disparity map between the first image data and the second image data; and
estimating a visibility level based on the disparity map between the first image data and the second image data.

14. The vehicle of claim 13, the method further comprising the step of increasing the brightness of one or more lights of the vehicle in accordance with the estimated visibility level being below a predetermined threshold.

15. The vehicle of claim 13, the method further comprising the step of activating one or more fog lights of the vehicle in accordance with the estimated visibility level being below a predetermined threshold.

16. The vehicle of claim 13, the method further comprising the step of disabling a driving assistance system in accordance with the estimated visibility level being below a predetermined threshold.

17. The vehicle of claim 13, the method further comprising the step of reducing a confidence level of a driving assistance system in accordance with the estimated visibility level being below a predetermined threshold.

18. The vehicle of claim 13, wherein the the vehicle includes a stereo camera comprising a first image sensor and a second image sensor, wherein the first image data is captured by the first image sensor, and the second image data is captured by the second image sensor.

19. The vehicle of claim 18, wherein the first image sensor is a baseline distance from the second image sensor, and wherein the method further comprising the step of generating a depth map based on the disparity map and the baseline distance, wherein the estimated visibility level is based on the generated depth map.

20. The vehicle of claim 13, wherein the vehicle include a first image sensor, and both the first and second image data are captured by the first image sensor.

21. The vehicle of claim 20, the method further comprising the steps of:
determining a speed of the vehicle;
computing a baseline distance based on the speed of the vehicle and a time difference between the first image data and the second image data; and
generating a depth map based on the disparity map and the baseline distance, wherein the estimated visibility level is based on the generated depth map.

22. The vehicle of claim 13, the method further comprising the steps of:
detecting a first edge in the first image data;
determining a property of the first edge in the first image data;
in accordance with the property of the first edge not exceeding a predetermined threshold, generating the disparity map; and
in accordance with the property of the first edge exceeding the predetermined threshold, forgoing generation of the disparity map.

23. The vehicle of claim 13, the method further comprising the steps of:
generating a depth map based on the disparity map; and
determining a first density of pixels at a first distance in the depth map, wherein the estimated visibility level is based on the first density of pixels at the first distance in the depth map.

24. The vehicle of claim 23, the method further comprising the steps of:
determining a second density of pixels at a second distance in the depth map;
wherein the estimated visibility level is based on the first distance in the depth map in accordance the first density exceeding a predetermined density threshold;
wherein the estimated visibility level is based on the second distance in the depth map in accordance with the second density exceeding the predetermined density threshold and the first density not exceeding the predetermined density threshold.
